(19) United States
(12) Patent Application Publication
(10) Pub. No.: US 2012/0047027 A1
(43) Pub. Date: Feb. 23, 2012

(54) System and method of information fulfillment

(76) Inventors: Jayant Kadambi, Mountain View, CA (US); Ayyappan Sankaran, San Jose, CA (US); Michael Lu, San Jose, CA (US); Yogesh Dandekar, Pune (IN)

(21) Appl. No.: 12/805,853

(22) Filed: Aug. 20, 2010

(51) Int. Cl. G06Q 30/00; G06F 15/16

(52) U.S. Cl. 705/14.73; 709/227

(57) ABSTRACT

With the popularity of computers and micro-processor based entertainment and communication equipments, information gathering once took place in the library and marketplace is replaced with computer searches gathering needed information from around the globe. Understanding this new trend of information gathering by the masses, many commercialized information distributors resort to elaborate methods and systems of information distribution. However, despite of this proliferation of new technology, many commercialized information distributors are unknowingly imposing the limitations of information distribution of previous generations on the new technology. This invention removes these limitations and implements a system and method to more fully utilize the potentials of the new technology.

### BACKGROUND OF THE INVENTION

Web-based advertisement systems and methods are widely used on the Internet. Traditional systems basically deliver content of interest to targeted groups or individuals and considered the advertisement effect accomplished. Further actions are not taken. If the targeted groups or individuals need further information, they have to conduct further information gathering efforts on their own.

### SUMMARY OF THE INVENTION

The first object of the present invention is to delivered content of interest to targeted groups or individuals via the Internet.

The second object of the present invention is to prompt the targeted groups or individuals to provide further inquiries that would meet the needs of the targeted groups or individuals.

The third object of the present invention is to provide information corresponding to the prompted inquiries to the targeted groups or individuals as information fulfillment.

The fourth object of the present invention is to provide official websites of information source providers to the targeted groups or individuals.

The fifth object of the present invention is to provide accessible geographical information and contact information to the targeted groups or individuals.

The sixth object of the present invention is to facilitate direct communication between a user computer with an advertisement server and a database.

The seventh object of the present invention is to minimize traffics so as to achieve a speedy information fulfillment.

The eighth object of the present invention is to insulate a user computer from directly communicating with an advertisement server and a database.

The ninth object of the present invention is to record and data-mine information exchanged between a user computer, an advertisement server and a database.

The eleventh object of the present invention is to record and data-mine information exchanged between a user computer, an advertisement server and a database after information fulfillment is completed.

The twelve object of the present invention is to load a video player with a plug-in software to an Internet browser of a user computer or terminal so that the plug-in software can provide interpretation of an advertisement to be displayed on the Internet browser of the user computer or terminal.

Other objects of the present invention will become apparent upon a review of the written specification, drawings and claims as a whole.

### BRIEF DESCRIPTION OF THE DRAWING

FIG. 1 is a general network architecture of the present invention.

FIG. 2 is a first embodiment of a specific network architecture of the present invention.

FIG. 3 is a second embodiment of a specific network architecture of the present invention.

FIG. 4 is a computer user view of the present invention.

FIG. 5 is another computer user view of the present invention.

FIG. 6 is a screen view of information delivered to the user computer or terminal.

FIG. 7 is another screen view of additional information delivered to the user computer or terminal.

FIG. 8 is a further screen view of additional information delivered to the user computer or terminal.

FIG. 9 is a third embodiment of a specific network architecture of the present invention.

FIG. 10 is a first diagram giving a general hardware and software layout of the present invention.

FIG. 11 is a second diagram giving a general hardware and software layout of the present invention.

### DETAIL DESCRIPTION OF THE INVENTION

Internet-based advertisement is widely used for its inherent ability to reach a massive number of people and potential customers with relative operating ease, expedient delivery and low operating cost. While it is the latest preferred technology for advertisement, advertisers continue to use the latest technology with the mindset of traditional advertisement media like newspapers, flyers, radio and television. Specifically, advertisers continue to act under the limitations of traditional advertisement media and fail to capitalize on the immediate follow-up efforts that could lead to better advertising effects as the targeted groups or individuals have just paid specific attention to the advertised subject matter. The present invention attempts to detach from traditional media limitations and use the current technology to its potential by capitalizing on immediate follow-up efforts that could achieve a better advertising effect.

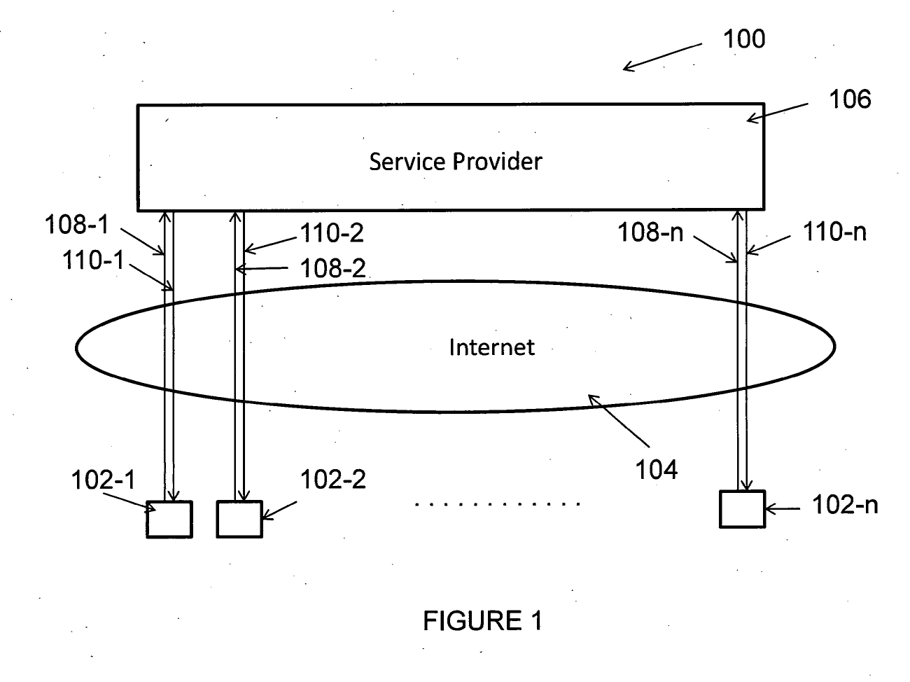

FIG. 1 shows a diagrammatic view of the present invention 100 where a plurality of user computers or terminals 102-1 to 102-n is connected to the Internet 104 to reach a service provider 106 as depicted by a plurality of arrows 108-1 to 108-n and the service provider 106 can reach the plurality of user computers or terminals via arrows 110-1 to 110-n.

The following discussion focuses upon user computer or terminal 102-1 to illustrate workings of the present invention and the full feature of the present invention can be understood by being cognizant that at any moment in time, there could be multiple user computers or terminals accessing the same service provider 106. Upon receipt of a communication from user computer or terminal 102-1, further communications can be provided by the service provider 106 to the user computer or terminal as depicted by arrow 110-1. An example of such mode of communication could be the user computer directly reaching the electronic presence of service provider 106 or via re-routing by search engines, links, etc. to reach the electronic presence of service provider 106. User computers or terminals 110-1 to 110-n can of course be personal computers or server terminals in the conventional sense. Given many forms of microprocessor-based devices in the marketplace are not called computers or terminals, but for the purpose of this invention, they are regarded as computers or terminals by virtue of their microprocessor controlled features. These types of devices include but not limited to personal pocket devices, portable pocket devices, smart phones, IPODs, IPADs, IPHONES, personal assistants, GPS's, mini-computers, televisions, game consoles like game boys, Sony Play Stations, Nintendo's, X-boxes, Wii, etc. Given most if not all of these microprocessor-based devices are connected to the Internet via satellites, repeaters, wireless routers, gateways, etc., it should be understood FIG. 1 is a generic diagram illustrative of connections without excluding any specific type of intervening devices necessary for a successful connection.

In addition to the above explained user computer or terminal 102-1 initiated model of communication, it is also possible for a service provider 106 initiated model of communication. In this case, service provider 106 may initiate contact with user computer 102-1 as depicted by arrow 110-1. For example, such service provider initiated contact could be through email advertisements, pop-up advertisements or pre-existing advertisements, etc. appearing on the user computer or terminal 102-1. Once the targeted-individual shows interest of any information perceived, that individual may communicate with the service provider 106 as depicted by arrow 108-1.

One should recognize that bi-lateral communication is not always necessary before further communication can be made possible. Once communication is successfully established either unilaterally or bilaterally between the user computer or terminal 102-1 and service provider 106, information fulfillment can be made possible.

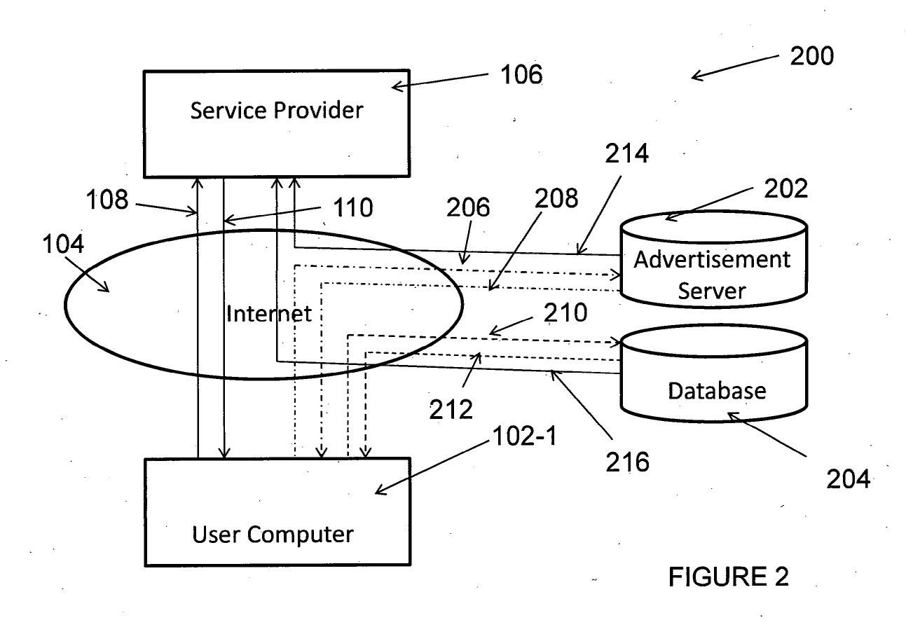

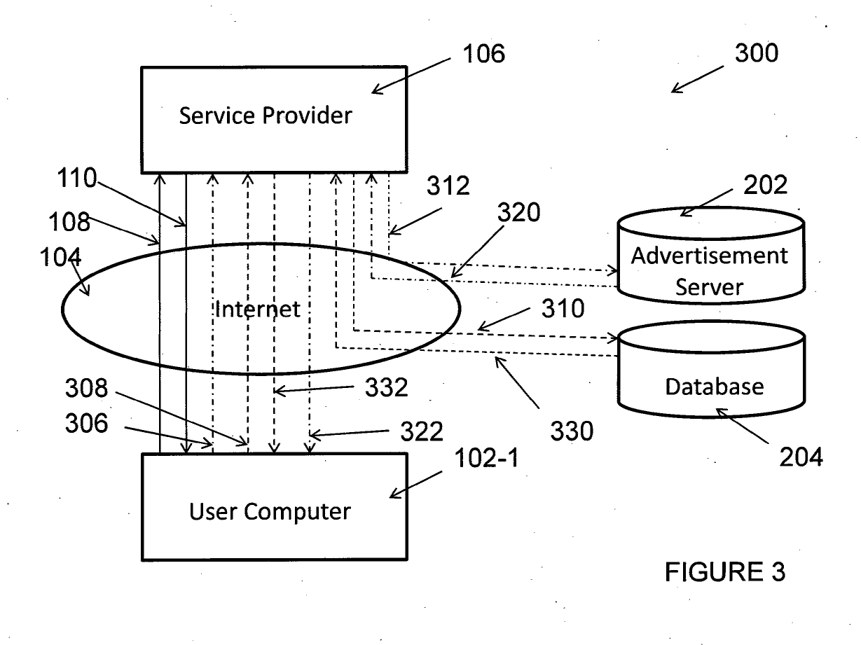

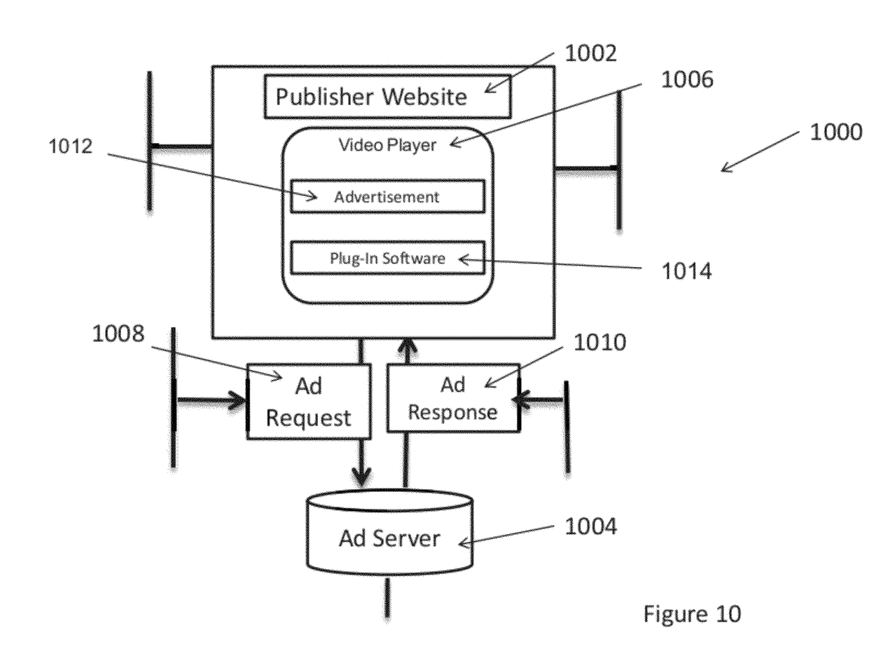

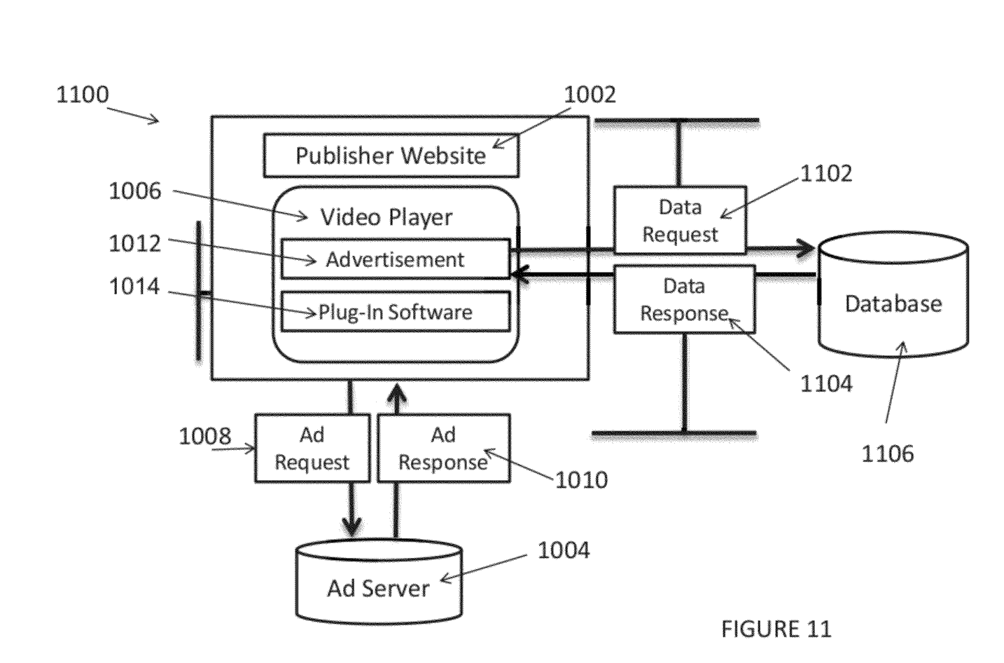

FIGS. 2 and 3 provide two specific embodiments of the present invention which could facilitate information fulfillment. Before addressing specific features and details of FIGS. 2 and 3, a general description of their features is given in FIGS. 10 and 11 as depictions 1000 and 1100. Generally, a user can visit a publisher website 1002 via an internet browser. The publisher website 1002 along with a video player and a plug-in software 1014 can be loaded onto the browser with various components. This can include but not limited to, for example, images, text, and an online video player, among other possibilities. It should be understood that a user can also visit a publisher web site through a mobile application or a computer application other than a web browser.

Once the user has clicked on an icon or link to request a piece of interested content appearing on an advertisement menu of the publisher website 1002, an advertisement request 1008 is made to the advertisement server 1004. This advertisement request 1008 can contain information about the publisher, the content and the user, among other possibilities. This can include Geo-location, Content Metadata and User cookie data, among other possibilities.

The advertisement server 1004 would process the advertisement request 1008 from the video player 1006. This process matches the information that is sent by the advertisement request 1008 with the campaign criteria stored in the advertisement server 1004. The advertisement server 1004 has to make a decision upon receipt of the advertisement request 1008. An advertisement response 1010 is sent from the advertisement server 1004 back into the video player 1006. This advertisement response 1010 can contain the video creative, business rules, and rendering rules that the video player 1006 will process. The present invention can define “advertisement” 1012 as a package of components that is sent to the video player 1006. This package of components can include but not limited to video creative, business rules, rendering rules and data request, among other possibilities. Once the advertisement is loaded into the video player 1006, various components will launch their own codes. The plug-in software 1014 would interpret the advertisement in the form of data-stream from the advertisement server so that the advertisement can be properly displayed on the user computer or terminal. One of this package of components is the data request 1102 feature. The data request 1102 feature can be one of various components that the advertisement 1012 can launch. Data request 1102 can be done as an auto data request or a user initiated data request. This data request 1102 could contain various information pertaining to the user, the content, and the advertiser, among other possibilities. The database 1106 will process the request 1102 and based on the various criteria of the request 1102 in terms of geo, content, user, among other possibilities, a data response 1104 is sent back to the advertisement 1012. This response 1104 is then displayed back by the video player 1006 after being interpreted by the plug-in software 1014 into a format recognizable and playable by the internet browser. Thus, the advertisement 1012 now has specific data that is related to the user and/or the content that is being displayed.

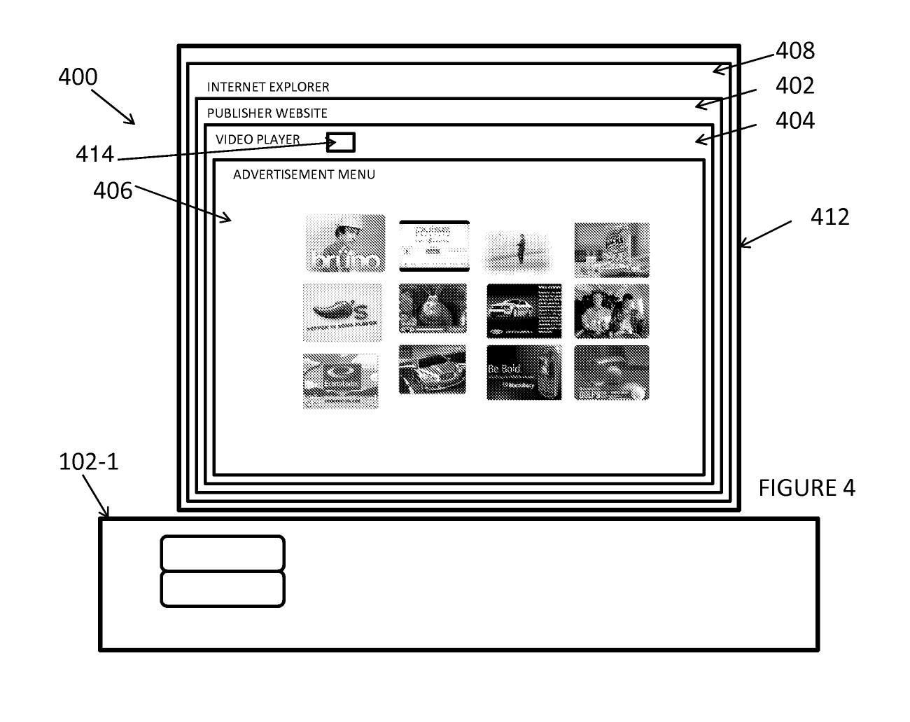

FIG. 2 shows a first embodiment of the present invention. In an example use thereof, a user computer 102-1 could visit service provider 106 via internet 104. FIG. 4 shows an example screen 412 of the user computer 102-1, where an internet browser such as an internet explorer 408, firefox, etc. or other browser brand representatively shown as occupied one screen layer, publisher website 402 representatively shown as occupied a second screen layer, video player 404 with a plug-in software 414 representatively shown as occupied a third screen layer and advertisement menu 406 representatively shown as occupied a fourth screen layer. It should be noted that separate layers of screens are representatively shown only and they need not co-exist at the same time. They may appear individually at different phases of using the present invention. Even though the video player 404 is shown to be a separate screen, it can be one of the components of the publisher website 402. Alternatively, it could either be a software program loaded from the service provider 106 or a resident software program preinstalled on the user computer 102-1 that can be executed. In this specification, download also include situations where programs or data transmitted to the user computer 102-1 by loading, streaming, data-streaming, etc.

From the advertisement menu 406, a selection may be made. Upon activation of a selection, an advertisement request depicted as arrow 206 in FIG. 2 is communicated to advertisement server 202. The advertisement request 206 could contain information about the publisher, the content and the user, such as geographical location, content metadata, and user cookie data, among other possibilities. The advertisement server 202 processes the advertisement request 206 by matching the information sent by the advertisement request 206 with appropriate campaign criteria residing in the advertisement server 202. Upon finding a match, the advertisement server 202 sends an advertisement response as depicted by arrow 208 to the video player 404 with a plug-in software 414, or a resident video player of user computer or terminal 102-1. This advertisement response 208 could contain the video creative, business rules, and rendering rules among other possibilities that the video player needs to process.

In this example usage, “advertisement” is a package of components that is sent to video player 404 and interpreted by the plug-in software 414 rendering the advertisement displayable on the internet browser of the user computer or terminal 102-1. These components can include video creative, business rules, rendering rules and data request, among other possibilities. Once the video player 404 has loaded the advertisement, various components would launch their own codes.

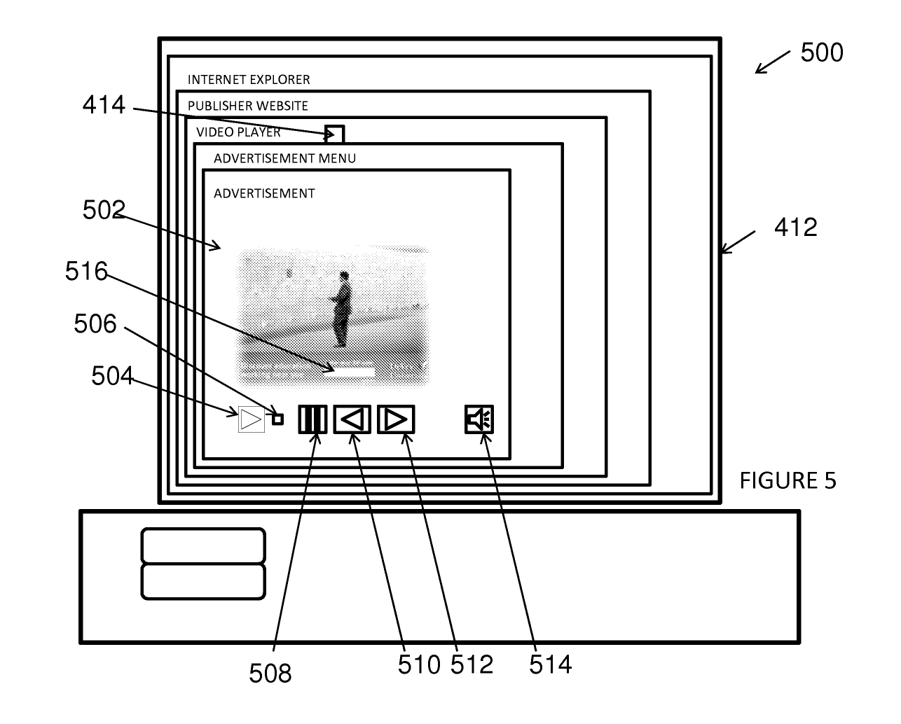

FIG. 5 shows advertisement 502 selected from advertisement menu 406 in FIG. 4 being displayed on screen 412. The advertisement may be played as depicted by play icon 504, stopped as depicted by stop icon 506, paused as depicted by pause icon 508, rewound as depicted by rewind icon 510, fast-forwarded as depicted by fast-forward icon 512, and asserted sound control as depicted by sound control icon 514. Within the duration of playing the advertisement and thereafter, a data request prompt 516 is always present. At any time a user deems appropriate, data may be entered into this data request prompt 516 as an indication more information is required. Data could be gender based, geographical base, model specific base, individual base, chronological based or any bases under which differentiation, categorization and identification could be made that is appropriate for the nature of the advertisement. In the instant example, the exampled advertisement is for DeVry University™. One of the objectives of this advertisement is to lead potential students to the closest campus in which they can enroll. Therefore, the data prompt is designed to be geographical based. Once a potential student enters geographical information such as a zip code, the data requested information is communicated to database 204 depicted as arrow 210 in FIG. 2.

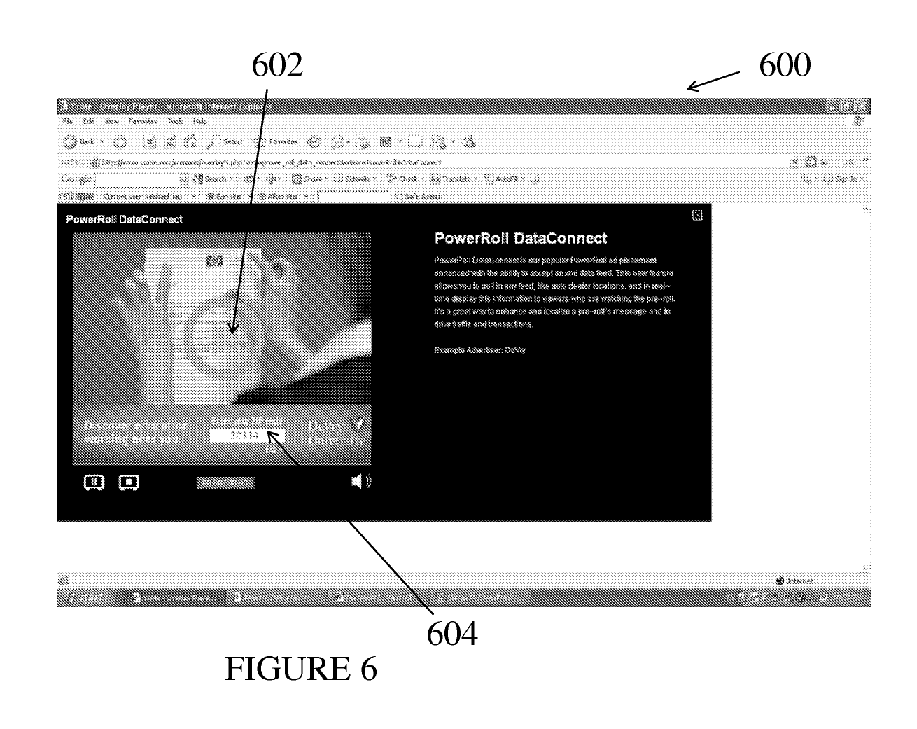

The advertisement could continue to play or simply stop once a data request 210 is made. The decision depends upon advertiser preferences. Some advertisers prefer targeted viewers to fully comprehend the advertisement before proceed further. Other advertisers prefer speedy delivery of viewer requested information. FIG. 6 shows an example that once a zip code is entered into data prompt 516, the advertisement is paused with a play icon 602 prominently displayed so that users have a choice whether to continue viewing the advertisement or proceed with viewing the data requested.

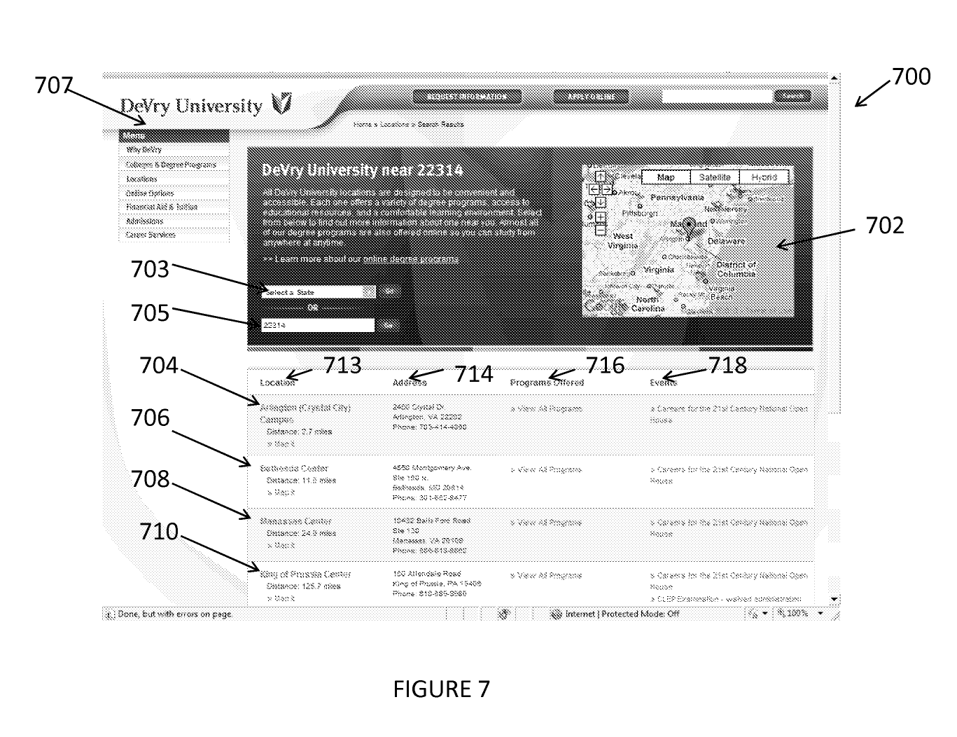

Database 204 upon receipt of the data request 210 proceeds to process the data request and deliver the requested data 212 to user computer or terminal 102-1. FIGS. 6-7 are information matching the requested data in this example. There is some overlapped information covered by both figures. Shown in a geographical map format is a campus location of a DeVry University™ located closest to the user typed-in zip code.

Displaying below the geographical map format is tabulated information regarding campuses located surrounding the typed-in zip code. As shown, they are the Arlington campus 704, Bethesda campus 706, Manassas campus 708, King of Prussia campus 710 and Philadelphia campus 712. Corresponding with each campus are contact information 714, programs offered 716 and up-coming or on-going note-worthy events 718. Based on user interest, a selection can be made from campus location 713, contact information 714, program offered 716 and events 718, and the requested information can be delivered.

Should the user wishes to explore campus locations other than those already displayed, state prompt 703 and zip code prompt 705 may be used to seek other campus locations. A menu 707 is also available to provide information for example related to Why choose DeVry University™, College & Degree Programs, Locations, Online Options, Financial Aid & Tuition, Admissions and Career Services. All selections may be clicked by a user and appropriate linked information would appear.

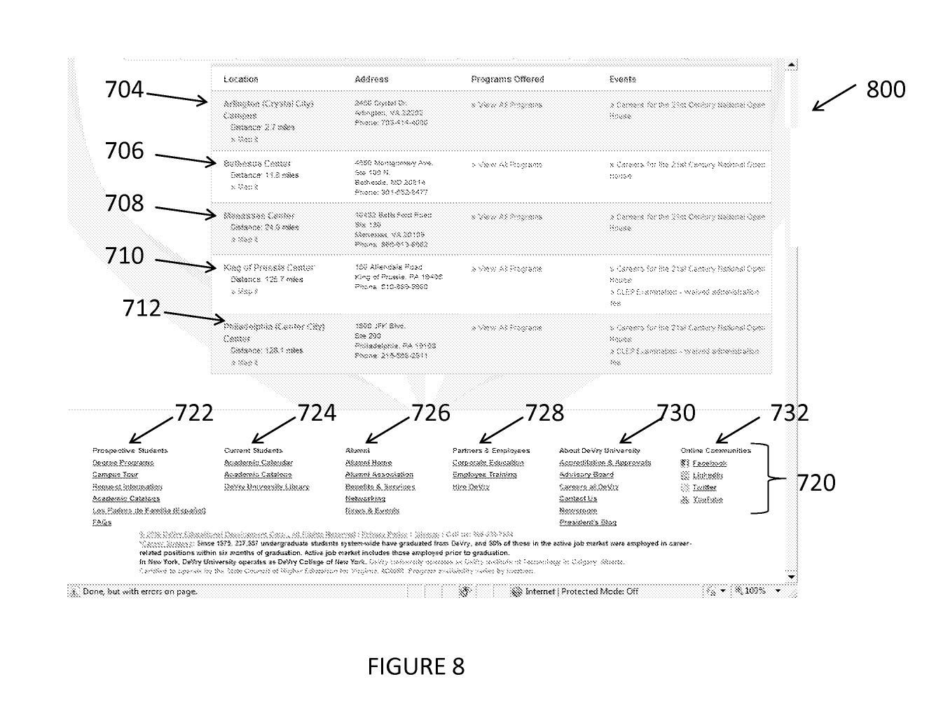

On FIG. 8 is shown screen 800 containing main menu 720 which breaks down into sub-menus for Perspective Students 722, Current Students 724, Alumni 726, Partners & Employees 728, About DeVry University™ 730 and Online Communities 732. Under each sub-menu is shown a number of selections of interest, clicking of which would lead to linked information for the viewing convenience of the user.

Even though this example uses DeVry University™ as illustrations of what information could be provided by the data request features, it should be understood that this is merely one of endless number of examples the present invention can be tailored to provide. Therefore, this example should not be viewed in a restrictive way unduly limiting the potential usage of the present invention. The information provided by data request could be tailor-made information on behalf of an advertising client or simply a link to the website of the advertising client.

The architecture shown in FIG. 2 is a minimum traffic and fastest response time model whereby after the initial contact between user computer or terminal 102-1 and service provider 106, traffic is directed to achieve direct communication between user computer or terminal 102-1 with advertisement server 202 and database 204. With minimum traffic, request, response and delivery times are kept to a minimum to ensure speedy information fulfillment. This model is quite useful for advertisers who do not need the service provider to data mine any detailed information exchanged between user computer or terminal 102-1 and advertisement server 202 and database 204. However, if the advertiser wishes data mining, at the end of all information exchanges such as when publisher website 402 is cancelled, video player 404 is cancelled, advertisement menu 406 is canceled, advertisement 502 is canceled, user computer or terminal 102-1 is turned off or other designated triggering events, a detailed report can be transmitted from advertisement server 202 and database 204 to service provider 106 as representatively shown by arrows 214 and 216.

To make correspondence of detailed reports possible, when information is loaded from service provider 106 to user computer or terminal 102-1, such as when publisher website 402, video player 404 with plug-in software 414 or advertisement menu 406 was loaded to the internet browser of the user computer or terminal 102-1, an identifier is loaded therewith as well. This identifier would be the key that matches the detailed reports from advertisement server 202 and database 204. In this example, given the detailed report is transmitted after information fulfillment is completed, the user computer or terminal 102-1 never experienced any un-necessary delays. The architecture shown in FIG. 3 is a secured and detailed data mining model, whereby user computer or terminal 102-1 cannot directly communicate with advertisement server 202 and database 204. All communications must go through service provider 106. As all communications among advertisement 202, database 203 and user computer 102-1 are exclusively with service provider 106, the overall integrity of the advertisement server 202 and database 204 can be assured.

This model would be ideal to serve older user computers or terminals 102-1 to 102-n with less powerful capabilities in terms of processor speed, storage capacities and latest software capabilities. The service provider would then be able to use its capabilities to process everything on its end and send the processed information that requires minimum level of local processing time, storage capacity and software capabilities to the user computers or terminals 102-1 to 102-n.

Given all communications from user computers or terminals 102-1 to 102-n must go through service provider 106, provider 106 functions as a first line of defense for virus attacks, security breaches and hacker attempts and other harms against the service provider 106, advertisement server 202 and database 204.

The architecture of FIG. 3 could also be used to data mine and record information exchanges between the user computers or terminals 102-1 to 102-n, advertisement server 202 and database 204.

In an example use of the FIG. 3 embodiment, a user computer 102-1 could visit service provider 106 via internet 104. FIG. 4 shows an example screen 412 of the user computer 102-1, where an internet browser such as an internet explorer 408 or another browser brand representatively shown as occupying one screen layer, publisher website 402 representatively shown as occupying a second screen layer, video player 404 with plug-in software 414 representatively shown as occupying a third screen layer and advertisement menu 406 representatively shown as occupied a fourth screen layer. The representative layers of screens need not co-exist at the same time, they may simply exist singly or in combination at different times. Even though the video player 404 is shown to be a separate screen, it could be one of the components of the publisher website 402. Alternatively, it could either be a software program loaded from the service provider 106 or a resident software program preinstalled on the user computer 102-1 that can be independently executed.

From the advertisement menu 406, a selection may be made. Upon activation of a selection, an advertisement request depicted as arrow 306 is communicated to service provider 106 which in turn directs to advertisement server 202 as depicted by instruction arrow 312 after any processing events are completed at service provider 106. The advertisement request 306 could contain information about the publisher, the content and the user, such as geographical location, content metadata, and user cookie data, among other possibilities. The advertisement server 202 processes the instruction arrow 312 by matching the information sent by the advertisement request 306 with appropriate campaign criteria residing in the advertisement server 202. Upon finding a match, the advertisement server 202 sends an advertisement response as depicted by arrow 320 to service provider 106 and in turn to video player 404 and plug-in software 414 of user computer or terminal 102-1. This advertisement response 320 could contain the video creative, business rules, and rendering rules among other possibilities that the video player needs to process.

In this example usage, “advertisement” is a package of components that is sent to video player 404 and interpreted by the plug-in software preparing for display. These components can include video creative, business rules, rendering rules and data request, among other possibilities. Once the video player 404 has loaded the advertisement, various components would launch their own codes.

FIG. 5 shows advertisement 502 selected from advertisement menu 406 being displayed on screen 412. The advertisement may be played as depicted by play icon 504, stopped as depicted by stop icon 506, paused as depicted by pause icon 508, rewound as depicted by rewind icon 510, fast-forwarded as depicted by fast-forward icon 512, and asserted sound control as depicted by sound control icon 514. Within the duration of playing the advertisement and thereafter, a data request prompt 516 is always present. At any time a user deems appropriate, data may be entered into this data request prompt 516 as an indication more information is required. Data could be gender based, geographical base, model specific base, individual base, chronological based or any bases under which differentiation, categorization and identification could be made that is appropriate for the nature of the advertisement. In the instant example, the exampled advertisement is for DeVry University™. One of the objectives this advertisement is to lead potential students to the closest campus in which potential students can enroll. Therefore, the data prompt is designed to be geographical based. Once a potential student enters geographical information such as a zip code, the data request information 308 is communicated to service provider 106 which in turn is directed to database 204 by instruction request 310 after any processing event is completed at service provider 106.

The advertisement could continue to play or simply stop once a data request 308 is made or a response to request 308 is ready to be played. The decision depends upon advertiser preferences. Some advertisers prefer targeted viewers to fully comprehend the advertisement before proceed further. Other advertisers prefer speedy delivery of viewer requested information. FIG. 6 shows an example that once a zip code is entered into data prompt 516, the advertisement is paused with a play icon 602 prominently displayed so that users have a choice whether to continue viewing the advertisement or proceed with viewing the data requested.

Database 204 upon receipt of the data request 310 proceeds to process the data request 308 and deliver the requested data 330 to service provider 106 and in turn to user computer or terminal 102-1 via arrow 332. FIGS. 6-7 are information matching the requested data in this example. There is some overlapped information covered by both figures. Shown in a geographical map format is a campus location of a DeVry University™ located closest to the user typed-in zip code.

Displaying below the geographical map format is tabulated information regarding campuses located surrounding the typed-in zip code. As shown they are the Arlington campus 704, Bethesda campus 706, Manassas campus 708, King of Prussia campus 710 and Philadelphia campus 712. Corresponding with each campus are contact information 714, programs offered 716 and up-coming or on-going note-worthy events 718. Based on user interest, a selection can be made from campus location 713, contact information 714, program offered 716 and events 718, and the requested information can be delivered.

Should the user wishes to explore campus locations other than those already displayed, state prompt 703 and zip code prompt 705 may be used to seek other campus locations. A menu 707 is also available to provide information for example related to Why choose DeVry University™, College & Degree Programs, Locations, Online Options, Financial Aid & Tuition, Admissions and Career Services. All selections may be clicked by a user and appropriate linked information would appear.

On FIG. 8 is shown screen 800 containing main menu 720 which breaks down into sub-menus for Perspective Students 722, Current Students 724, Alumni 726, Partners & Employees 728, About DeVry University™ 730 and Online Communities 732. Under each sub-menu is shown a number of selections of interest, clicking of which would lead to linked information for the viewing convenience of the user.

Even though this example uses DeVry University™ as illustrations of what information could be provided by the data request features, it should be understood that this is merely one of endless number of examples the present invention can be tailored to provide. Therefore, this example should not be viewed in a restrictive way unduly limiting the potential usage of the present invention. The information provided by data request could be tailor-made information on behalf of an advertising client or simply a link to the website of the advertising client. Therefore, instead of the single tier advertisement of prior generation technology, the present invention provides multi-tier information fulfillment.

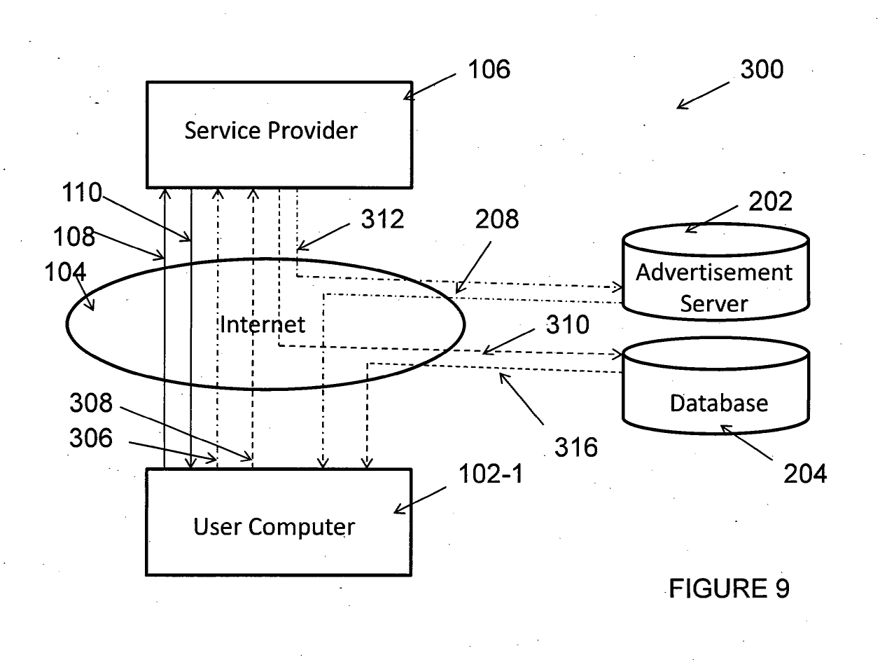

FIG. 9 shows another architecture as compared to the embodiments shown in FIGS. 2-3. This embodiment is a hybrid of the embodiments in FIGS. 2-3 in that it provides security to the advertisement server 202 and database 204 yet provides expedient information fulfillment by making them download capable only and directly to the user computer or terminal 102-1 by passing service provider 106. As many of the reference numerals in FIG. 9 are the same as those in FIG. 3, explanations with the same reference numerals are adopted herein.

More specifically, user terminal 102-1 communicates its information needs to the service provider 106 via arrow 306. Information needs 306 are communicated by the service provider 106 to advertisement server 202 via arrow 312. Fulfillment information corresponding to information needs 306 are directly loaded from advertisement server 202 to user computer or terminal 102-1 via arrow 208.

Similarly, once the user computer or terminal 102-1 communicates its information requirements to service provider 106 via arrow 308, Service provider 106 communicates the same information requirement to the database 204 via arrow 310. Database 202 then communicates information fulfillment to the user computer or terminal 102-1 via arrow 316. Notice advertisement server 202 and database 204 are loaded only with respect to user computer or terminal 102-1 and they cannot upload anything therefrom the user computer or terminal 102-1. Therefore, overall integrity of the advertisement server 202 and database 204 can be ensured.

1. A multi-tier information fulfillment system, comprising:
a user terminal connected to a service provider via an Internet connection;
an advertisement server connected to the user terminal via the Internet connection;
a database connected to the user terminal via the Internet connection;
upon one of the service provider and the user terminal initiating contact with another one of the service provider and the user terminal, the another one of the service provider and the user terminal responds to the one of the service provider and user terminal to establish communication between the service provider and the user terminal;
wherein the user terminal communicates with the advertisement server bilaterally and directly via the Internet connection.

2. The multi-tier information fulfillment system of claim 1, wherein the user terminal communicates with the database directly via the Internet connection.

3. The multi-tier information fulfillment system of claim 1, wherein an advertisement and a correspondence identifier are loaded from the service provider to the user terminal and the advertisement is played on the user terminal.

4. The multi-tier information fulfillment system of claim 3, wherein the advertisement is played on the user terminal via a resident video player program preinstalled on the user terminal.

5. The multi-tier information fulfillment system of claim 4, wherein the advertisement is played on the user terminal via a video player with a plug-in software loaded from the service provider to the user terminal.

6. The multi-tier information fulfillment system of claim 3, wherein the advertisement is loaded from the service provider to the user terminal upon a selection of the advertisement from an advertisement menu at the user terminal after the advertisement menu is loaded from the service provider to the user terminal.

7. The multi-tier information fulfillment system of claim 6, wherein upon the selection of advertisement on the user terminal, information regarding the selection and the correspondence identifier are communicated to the advertisement server.

8. The multi-tier information fulfillment system of claim 7, wherein the information regarding the selection includes one of content identifier, geographic location of the user terminal, content metadata, and user cookie data of the user terminal.

9. The multi-tier information fulfillment system of claim 8, wherein the information regarding selection is processed at the advertisement server and the advertisement is located based on the content identifier.

10. The multi-tier information fulfillment system of claim 3, wherein playing along with the advertisement is an information prompt eliciting an input from the user terminal.

11. The multi-tier information fulfillment system of claim 10, wherein upon entry of the input at the information prompt, the input and the correspondence identifier are communicated directly to the database.

12. The multi-tier information fulfillment system of claim 11, wherein the database data stream to the user terminal information corresponding to the input.

13. The multi-tier information fulfillment system of claim 12, wherein the information is displayed at the user terminal one of immediately after download of the information corresponding to the input and immediately after displaying of the advertisement.

14. The multi-tier information fulfillment system of claim 1, wherein the advertisement server maintains a secondary record of all communications between the advertisement server and the user terminal, and the secondary record along with the correspondence identifier are communicated to the service provider at a predetermined trickling event.

15. The multi-tier information fulfillment system of claim 1, wherein the database maintains a tertiary record of all communications between the database and the user terminal, and the tertiary record along with the correspondence identifier are communicated to the service provider at a predetermined trickling event.

16. The multi-tier information fulfillment system of claim 14, wherein the tertiary record is matched to the user terminal by the correspondence identifier.

17. The multi-tier information fulfillment system of claim 15, and wherein the details record of database correspondence is matched to the user terminal by the correspondence identifier.

18. The multi-tier information fulfillment system of claim 5, wherein the plug-in software provides interpretation of the advertisement so that it can be played by the video player on an internet browser of the user terminal.

19. The multi-tier information fulfillment system of claim 3, wherein the advertisement from the advertisement server is in a format not displayable by an internet browser of the user terminal.

20. A multi-tier information fulfillment system, comprising:
a user terminal connected to a service provider via an Internet connection;
an advertisement server connected to the user terminal via the Internet connection;
a database connected to the user terminal via the Internet connection;
upon one of the service provider and the user terminal initiating contact with another one of the service provider and the user terminal, the another one of the service provider and the user terminal responds to the one of the service provider and user terminal to establish bilateral communication between the service provider and the user terminal;
wherein the advertisement server communicates to the user terminal unilaterally and directly via the Internet connection.

21. The multi-tier information fulfillment system of claim 20, wherein the database communicates to the user terminal unilaterally and directly via the Internet connection.

22. The multi-tier information fulfillment system of claim 20, wherein an advertisement is loaded from the advertisement server to the user terminal and the advertisement is played on the user terminal.

23. The multi-tier information fulfillment system of claim 22, wherein the advertisement is played on the user terminal via a resident video player program preinstalled on the user terminal.

24. The multi-tier information fulfillment system of claim 23, wherein the advertisement is played on the user terminal via a video player with a plug-in software loaded from the service provider to the user terminal.

25. The multi-tier information fulfillment system of claim 22, wherein the advertisement is loaded from the advertisement server to the user terminal upon a selection of the advertisement from an advertisement menu at the user terminal after the advertisement menu is loaded from the service provider to the user terminal.

26. The multi-tier information fulfillment system of claim 25, wherein upon the selection of advertisement on the user terminal, information regarding the selection is communicated to the service provider and the selection is communicated by the service provider to the advertisement server.

27. The multi-tier information fulfillment system of claim 26, wherein the information regarding the selection includes one of content identifier, geographic location of the user terminal, content metadata, and user cookie data of the user terminal.

28. The multi-tier information fulfillment system of claim 27, wherein the information regarding selection is processed at the advertisement server and the advertisement is located based on the content identifier.

29. The multi-tier information fulfillment system of claim 22, wherein playing along with the advertisement is an information prompt eliciting an input from the user terminal.

30. The multi-tier information fulfillment system of claim 29, wherein upon entry of the input at the information prompt, the input is communicated directly to the service provider and the service provider communicates to the database.

31. The multi-tier information fulfillment system of claim 30, wherein the database loads information corresponding to the information prompted to the user terminal.

32. The multi-tier information fulfillment system of claim 31, wherein the information is displayed at the user terminal one of immediately after downloading of the information and immediately after displaying of the advertisement.

33. The multi-tier information fulfillment system of claim 24, wherein the plug-in software provides interpretation of the advertisement so that it can be played by the video player on an internet browser of the user terminal.

34. The multi-tier information fulfillment system of claim 22, wherein the advertisement from the advertisement server is in a format not displayable by an internet browser of the user terminal.

35. An Internet advertisement method of allowing a recipient of an advertisement to seek further information, comprising a plurality of steps of:
loading the advertisement from an advertisement server to a user terminal;
playing the advertisement on the user terminal by a resident player or a video player with a plug-in software loaded from a service provider prior to or concurrent with loading the advertisement;
presenting an information prompt at the user terminal to elicit an input throughout the duration and thereafter playing of the advertisement;
entering the input into the information prompt at the user terminal;
communicating the input from the information prompt with a database;
loading from the database to the user terminal information corresponding to the input.

36. An Internet advertisement method of allowing a recipient of an advertisement to seek further information, comprising a plurality of steps of:
establishing a communication between a service provider and a user terminal via an Internet connection;
loading a publisher website information from the service provider to the user terminal;
loading a video player with a plug-in software from the service provider to the user terminal;
loading an advertisement menu from the service provider to the user terminal;
selecting the advertisement from the advertisement menu at the user terminal.

37. The Internet advertisement method of claim 36, further comprising a step of:
communicating the selection from the user terminal to the service provider.

38. The Internet advertisement method of claim 37, further comprising a step of:
maintaining a primary record of all communications from the user terminal to the service provider.

39. The Internet advertisement method of claim 37, further comprising a step of:
communicating the selection from the service provider to the advertisement server.

40. The Internet advertisement method of claim 36, further comprising a step of:
communicating the selection from the user terminal to the advertisement server.

41. The Internet advertisement method of claim 40, further comprising a step of:
maintaining at the advertisement a secondary record of all communications from the user terminal to the advertisement server.

42. The Internet advertisement method of either claim 39 or 40, further comprising a step of:
loading the advertisement from the advertisement server to the user terminal.

43. The Internet advertisement method of claim 42, further comprising a step of:
playing the loaded advertisement on the video player at the user terminal.

44. The Internet advertisement method of claim 43, further comprising a step of:
displaying an information prompt at the user terminal to elicit an input throughout the duration and thereafter playing of the advertisement.

45. The Internet advertisement method of claim 44, further comprising a step of:
entering the input at the user terminal.

46. The Internet advertisement method of claim 39, further comprising a step of:
communicating the input from the user terminal to the service provider.

47. The Internet advertisement method of claim 43, further comprising a step of:
communicating the input from the service provider to a database.

48. The Internet advertisement method of claim 45, further comprising a step of:
communicating the input from the user terminal to a database.

49. The Internet advertisement method of claim 48, further comprising a step of:
maintaining at the database a tertiary record of all communications from the user terminal to the database.

50. The Internet advertisement method of either claim 47 or 48, further comprising a step of:
loading from the database to the user terminal information corresponding to the input.

51. The Internet advertisement method of claim 50, further comprising a step of:
communication the secondary record and tertiary record to the service provider upon a predetermined trickling event.

52. The Internet advertisement method of claim 43, wherein the plug-in software provides interpretation of the advertisement so that it can be played by the video player on an internet browser of the user terminal.

53. The Internet advertisement method of claim 42, wherein the advertisement from the advertisement server is in a format not displayable by an internet browser of the user terminal.

54. A multi-tier information fulfillment system, comprising:
a user terminal connected to a service provider via an Internet connection;
an advertisement server connected to the user terminal via the Internet connection;
a database connected to the user terminal via the Internet connection;
upon one of the service provider and the user terminal initiating contact with another one of the service provider and the user terminal, the another one of the service provider and the user terminal responds to the one of the service provider and user terminal to establish bilateral communication between the service provider and the user terminal;
wherein the advertisement server exclusively communicates with the service provider, the database exclusively communicates with the service provider and the service provider exclusively communicates with the user terminal.
